(19) United States
(12) Patent Application Publication
(10) Pub. No.: US 2019/0114704 A1
(43) Pub. Date: Apr. 18, 2019

(54) STATISTICAL MODEL FOR MAKING LENDING DECISIONS

(71) Applicant: QCash Financial, LLC, Olympia, WA (US)

(72) Inventors: Steve Way, Sherwood, OR (US); Ben Morales, Olympia, WA (US); Heidi Tinsley, Tumwater, WA (US); Mark Baumgartner, Olympia, WA (US)

(21) Appl. No.: 15/783,944

(22) Filed: Oct. 13, 2017

(51) Int. Cl. G06Q 40/02; G06N 7/00

(52) U.S. Cl. CPC G06Q 40/025; G06N 7/005

(57) ABSTRACT

A statistical model enables a lender financial institution to leverage multiple relationship attributes of a borrower to predict whether the borrower is capable of timely paying back a loan. The statistical model is generated to provide a multitude of relationship attribute coefficients based on historical borrower data of a multiple borrowers from an alternative loan approval process. The multitude of relationship attribute coefficients are applied to corresponding relationship attribute values of a borrower that is seeking a loan from a financial institution to generate an intermediate borrower score for the borrower. A probability of the borrower not being charged off on a loan after a predetermine time period is then calculated based on the intermediate borrower score. Accordingly, the loan may be determined to be approved or denied based on a comparison of the probability to an approval cutoff threshold.

### BACKGROUND

Good financial habits and credit use practices are important to the financial well-being of consumers. Consumer may occasionally need to borrow small amounts of money for a short amount of time to maintain financial sustainability. While most consumers have access to the financial services and products offered by financial institutions such as banks and credit unions, traditional lending practices of such financial institutions are not well suited to provide such small dollar value, short-term loans to consumers. These traditional lending practices are generally designed to provide long-term loans of relatively large amounts of funds for major goals based on collateral of valuable assets owned by the consumers. Additionally, these traditional lending practices may rely on time-consuming and lengthy credit worthiness checks, in many cases even when the consumers are existing customers of the financial institutions, which are impractical for meeting the immediate cash needs of consumers. As a result, some consumers who desire small short-term loans may be forced to turn to third-party lenders that do not view the consumers as long-term customers, and who also do have any incentive to educate the consumers in the responsible use of credit.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for implementing a statistical loan engine that performs statistical analysis on the relationship attributes of a borrower to make a loan decision.

FIG. 2 is a block diagram showing various components of a statistical loan engine that performs statistical analysis on the relationship attributes of a borrower to make a loan decision.

FIG. 3 illustrates an example relationship attribute coefficient table and an example relationship attribute values table.

FIG. 4 is a flow diagram of an example process for using a statistical model to perform statistical analysis on the relationship attributes of a borrower to make a loan decision.

FIG. 5 is a flow diagram of an example process for applying relationship attribute coefficients to corresponding relationship attribute values to generate an intermediate borrower score.

FIG. 6 is a flow diagram of an example process for using a distribution function to calculate a probability value that determines whether a borrower is qualified for a loan.

### DETAILED DESCRIPTION

This disclosure is directed to techniques for using a statistical model to analyze the relationship attributes of a borrower to determine whether to approve a loan or deny a loan to the borrower. In various embodiments, the statistical model is initially specified and estimated based on historical borrower data from an alternative loan approval process using at least a probit equation. For example, the alternative approval process may use a heuristic model that generates a loan qualifier score using multiple relationship attributes. Once the statistical model is specified and estimated, the statistical model may be used to process online borrower requests for short-term loans that are received by a financial institution via a web-based secure (SSL) connection (the Internet). The statistical model is used to analyze multiple relationship attributes of a borrower that requested a loan from a financial institution, in which the relationship attributes quantify the relationship history of the borrower with the financial institution. The analysis of the relationship attributes via the statistical model produces an intermediate borrower score. For example, the relationship attributes may include a length of relationship of the borrower with the financial institution, a payment history that includes the number of times the borrower paid open and closed loan payments on time, a direct deposit history that includes the number of direct deposits for which the borrower is a primary account holder, electronic transaction history that includes the number of electronic transactions for which the borrower is a primary account holder, an aggregated deposit balance during a transactional period, etc. Subsequently, the probability of the borrower not being charged off on the loan after a predetermined time period (e.g., 30 days or more) is calculated based on the intermediate borrower score. A charge off is a declaration by a creditor that an amount of debt is unlikely to be collected, and this may occur when a borrower becomes delinquent on the debt. The probability is then compared to an approval cutoff threshold value to determine whether the borrower is approved for lending.

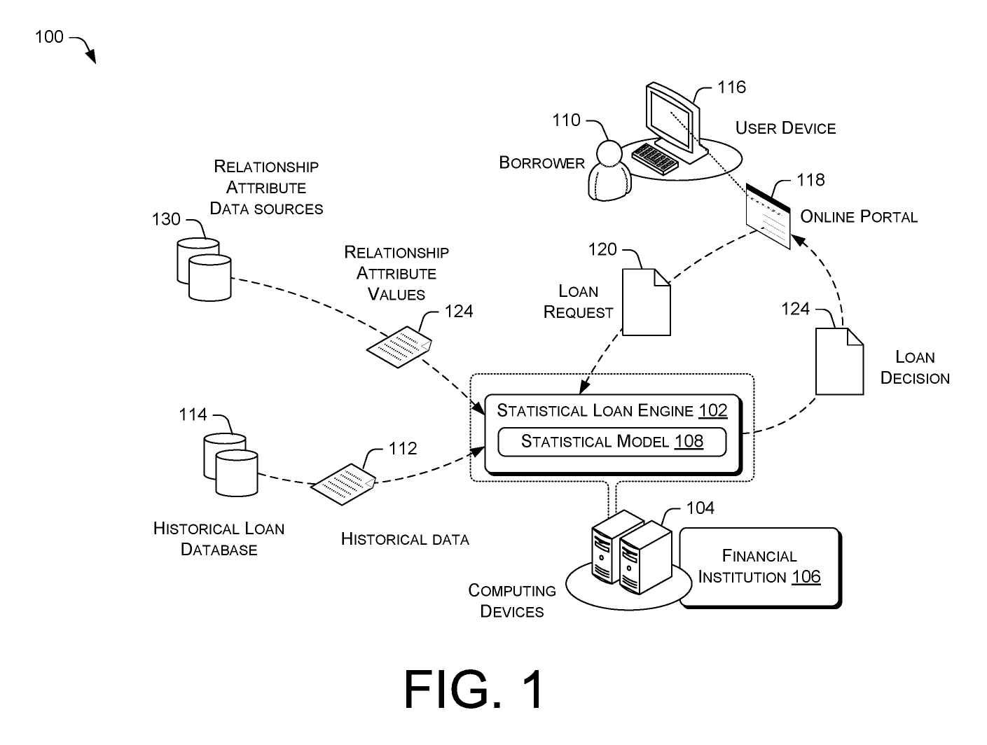

The statistical model enables a lender financial institution to leverage multiple relationship attributes of a borrower, in view of repayment histories of borrowers with similar attributes, to predict whether the borrower is capable of timely paying back a short-term loan. The statistical model may provide more accurate predictions of loan default probability than traditional techniques that rely solely on a borrower's credit score or a heuristic credit assessment of the borrower. Accordingly, such predictions may reduce incidents of loan defaults, reduce loan decision time, and provide near real-time loan approval or denial decisions to borrowers. Thus, the statistical model makes it practical for financial institutions to receive online requests for short-term loans from their existing customers via the Internet, automatically process the short-term loan requests without human intervention, and render loan decisions in near real-time for providing loans to their existing customers. The techniques described herein may be implemented in a number of ways. Example implementations are provided below with reference to the following FIGS. 1-6.

### Example Network Architecture

FIG. 1 illustrates an example environment 100 for implementing a statistical loan engine that performs statistical analysis on the relationship attributes of a borrower to make a loan decision. The environment 100 may include a statistical loan engine 102 that is implemented on one or more computing devices 104. The computing devices 104 may include general purpose computers, such as desktop computers, tablet computers, laptop computers, servers, or other electronic devices that are capable of receive inputs, process the inputs, and generate output data. In other embodiments, the computing devices 104 may be virtual computing devices in the form of virtual machines or software containers that are hosted in the cloud. The computing devices may be operated by a financial institution 106, or operated by a service provider on behalf of the financial institution 106. The financial institution may be a bank, a credit union, a savings & loan association, or another financial entity that provides investment, loan, and/or deposit services.

The statistical loan engine 102 may use a statistical model 108 to render a loan decision for a borrower 110 that desires to obtain a loan based on the relationship attributes of the borrower 110. The borrower 110 may be an existing customer of the financial institution 106. In various embodiments, the statistical model 108 is initially specified and estimated based on historical borrower data 112 from an alternative loan approval process, using a selection equation and a probit equation. For example, the alternative approval process may use a heuristic model that generates a loan qualifier score using multiple relationship attributes of a borrower, such as the borrower 110. The selection equation is an equation that relates relationship attributes to observable characteristics of the borrowers, such as whether the borrowers are delinquent with their loans. A probit equation is a type of regression where a dependent variable may take only two classification values, and the model is used to estimate a probability that an observation with specific attributes belong to one of the two possible classifications. Accordingly, a probit equation quantifies the relationships between the relationship attributes and the two possible classifications, e.g., delinquent on loan or not delinquent on loan.

In various embodiments, the relationship attributes of a borrower may include a length of relationship of the borrower with the financial institution, a payment history that includes the number of times the borrower paid open and closed loan payments on time, a direct deposit history that includes the number of direct deposits for which the borrower is a primary account holder, electronic transaction history that includes the number of electronic transactions for which the borrower is a primary account holder, an aggregated deposit balance during a transactional period, etc. The statistical loan engine 102 may receive the historical borrower data 112 from a historical loan database 114. The historical loan database 114 may be a database that is maintained by the financial institution 106, or maintained by a service provider on behalf of the financial institution 106.

The statistical model 108 may provide a set of relationship attribute coefficients that are useful for determining whether borrowers, such as the borrower 110, are able to repay their loans on time. For example, the relationship attribute coefficients may include an aggregate deposit (Dep) coefficient, one or more length of relationship (LoR) coefficients, one or more payment history (PayH) coefficients, a direct deposit (DirDep) coefficient, an electronic transactions (ElecTr) coefficient, a banking product (Prod) coefficient, a bill pay coefficient (BillPay), and an affiliate coefficient (Aff).

The borrower 110 may initiate a loan request to the statistical loan engine 102 via a user device 116. In some instances, the borrower 110 may visit an online portal 118 that is operated by the financial institution 106 using a web browser installed on the user device 116. The user device 116 may access the online portal 118 via a local area network (LAN), a larger network such as a wide area network (WAN), or a collection of networks, such as the Internet. The online portal 118 may provide a loan request interface page that enables the borrower 110 to initiate a loan request 120. The loan request interface page may be configured to permit the borrower 110 to initiate the loan request 120 after the borrower 110 has submitted authentication credentials that authenticates the borrower 110 as an existing customer of the financial institution 106. In other instances, the borrower 110 may visit the online portal via a financial application installed on the user device 116.

In response to the loan request from the borrower 110, the statistical loan engine 102 may implement three steps to determine whether a loan for a borrower is to be approved or declined. The first step is the application of the relationship attribute coefficients provided by the statistical model 108 to the corresponding relationship attributes of the borrower 110 to determine an intermediate borrower score for the borrower 110. For example, the relationship attributes of the borrower 110 may include an aggregate deposit (Dep) attribute, one or more lengths of relationship (LoR) attribute, one or more payment history (PayH) attributes, a bill pay (BillPay) attribute, an affiliate (Aff) attribute, and/or a banking product (Prod) attribute. In various embodiments, the statistical loan engine 102 may obtain the values of these relationship attributes from relationship attribute data sources 122 that are maintained directly by or maintained on behalf of the financial institution 106. In some instances, a relationship attribute data source may be a database that directly stores an attribute value. For example, the payment history (PayH) attribute quantifies the numbers of late payments to a total number of payments for an account by measuring a percentage of late payments to total payments. Thus, when the relationship attribute data sources 122 includes database that stores such a percentage for multiple borrowers, the statistical loan engine 102 may query this percentage value of the borrower 110 directly from such a relationship attribute database. In another example, the bill pay (BillPay) attribute indicates whether a bill pay product of the financial institution is used by the borrower 110, e.g., a value of “1” indicates at least one bill pay product is used, and a value of “0” indicates no bill pay product is used. Accordingly, the statistical loan engine 102 may query a database that stores such a value for the bill pay products used by the borrower 110 to obtain the BillPay attribute value.

In other instances, the statistical loan engine 102 may use a function to derive a relationship attribute value from the data in one or more relationship attribute data sources 122. For example, a length of relationship (LoR) attribute measures an amount of time that the borrower maintained a corresponding account with the financial institution. Accordingly, a function of the statistical loan engine 102 may query an account information database for an account establishment date of the account, and then calculate the LoR value based on difference between a current date and the account establishment date to derive the LoR attribute value. In another example, the aggregate deposit (Dep) attribute measures the aggregate deposit balance of a borrower with the lender during a transaction period. Accordingly, the data sources are the accounts of the borrower 110 with the financial institution. In such an example, a function of the statistical loan engine 102 may query each deposit account for a balance, and then perform an arithmetic operation to calculate the aggregate deposit balance, and hence, the Dep attribute value.

The second step is the calculation of the probability of the borrower 110 not being charged off on the loan after a predetermined time period (e.g., 30 days or more) based on the intermediate borrower score. In various embodiments, the statistical loan engine 102 may apply a distribution function, such as a Standard Normal Cumulative Distribution Function (CDF), to the intermediate borrower score to calculate the probability. The third step is the comparison of the probability to an approval cutoff threshold value to determine whether the borrower 110 is approved for lending. Thus, if the probability is at or above the cutoff threshold, the statistical loan engine 102 may approve a loan for the borrower 110. However, if the probability is below the cutoff threshold, the statistical loan engine 102 may deny the loan for the borrower 110. For example, if the approval cutoff threshold is 0.90, a calculated probability of 0.91 will result in the statistical loan engine 102 granting the loan. On the other hand, a calculated probability of 0.89 will result in the statistical loan engine 102 denying the loan.

The statistical loan engine 102 may present a loan decision 124 of either loan grant or loan denial to the borrower 110 via the online portal 118. For example, the loan decision 124 may be displayed via a webpage or application interface page that is displayed by the user device 116. In the event that the borrower 110 is granted a loan, the statistical loan engine 102 may also use one or more relationship attribute values or other factors to calculate an amount of the loan that is granted to the borrower 110.

### Example Statistical Loan Approval Engine Components

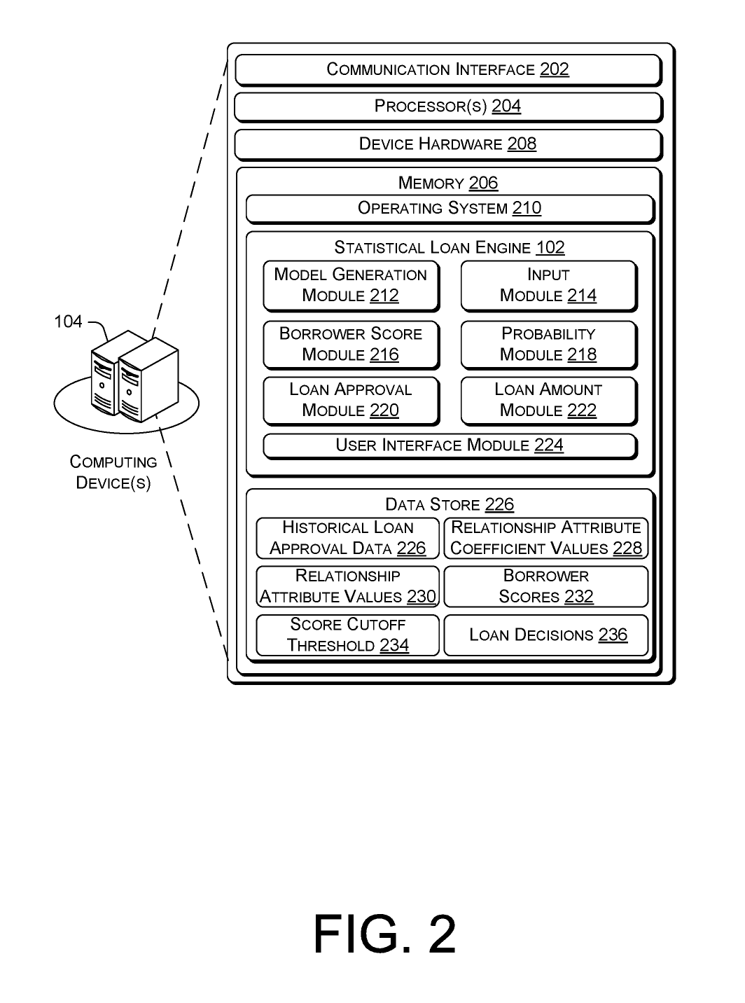

FIG. 2 is a block diagram showing various components of the statistical loan engine 102 that uses a statistical model to approve a loan. The statistical loan engine 102 may be implemented on the computing devices 104. The computing devices 104 may include a communication interface 202, one or more processors 204, memory 206, and device hardware 208. The communication interface 202 may include wireless and/or wired communication components that enable the computing devices to transmit data to and receive data from other networked devices. The device hardware 208 may include additional hardware that performs user interface, data display, data communication, data storage, and/or other functions.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital storage disks or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The processors 204 and the memory 206 of the computing devices 104 may implement an operating system 210 and the statistical loan engine 102. The operating system 210 may include components that enable the computing devices 104 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The statistical loan engine 102 may include a model generation module 212, an input module 214, a borrower score module 216, a delinquency probability module 218, a loan approval module 220, a loan amount module 222, and a user interface module 224. These modules may include routines, program instructions, objects, code segments, and/or data structures that perform particular tasks or implement particular abstract data types.

The model generation module 214 may specify and estimate the statistical model 108 based on historical borrower data of a random sample set of borrowers from an alternative loan approval process. The statistical model 108 may be specified and estimated using a selection equation and a probit equation. In at least one embodiment, the historical borrower data includes multiple relationship attributes of the sample set of borrowers, and the alternative approval process is a heuristic model that generates a loan qualifier score for each of the borrower using the multiple relationship attributes of each borrower. For example, the relationship attributes of a borrower in the sample set may include a length of relationship of the borrower with the financial institution, a payment history that includes the number of times the borrower paid open and closed loan payments on time, a direct deposit history that includes the number of direct deposits for which the borrower is a primary account holder, electronic transaction history that includes the number of electronic transactions for which the borrower is a primary account holder, an aggregated deposit balance during a transactional period, etc. The historical borrower data of the sample set of borrowers may further include whether each loan qualifier score generated by the heuristic model resulted in the borrower being approved or rejected for a loan, and whether each borrower who is approved for a loan is delinquent in paying back the loan, i.e., failed to pay back the loan in a predetermined time period.

The selection equation relates relationship attributes of the sample set of borrowers to observable characteristics of the borrowers, such as whether the borrowers are delinquent with their loans. The probit equation quantifies the relationships between the relationship attributes of the sample set of borrowers and the two possible classifications, e.g., delinquent on loan or not delinquent on loan. Accordingly, the model generation module 214 may process the historical borrower data using the selection equation and the probit equation to construct the statistical model 108.

Following the construction of the statistical model 108, the model generation module 214 may use the statistical model 108 and a validation sub-sample of the historical borrower data of the sample set of borrowers to construct a Receiver Operator Characteristic (ROC) curve and determine values of the associated Kolmogorov-Smirnov (K-S) statistic along the ROC curve. For example, the validation sub-sample may include historical borrower data that belong to an additional random sample set of borrowers. The additional random sample set of borrowers may be smaller in size than the random sample set of borrowers used for the construction of the statistical model 108.

The K-S statistic strikes a balance between loan defaults and loan volume. For example, the basic analysis definitions for the ROC may be as follows:

| | 1, condition + | 0, condition − |
|---|---|---|
| 1, test outcome + | “True +” (TP) | “False +” (FP) |
| 0, test outcome − | “False −” (FN) | “True −” (TN) |

Accordingly, key measures of model performance may include the following: (1) True Positive Rate (TPR)=TP/(TP+FN), which is the percentage of borrowers with good credit scored as having good credit (non-delinquent on loan); (2) False Positive Rate (FPR)=FP/(FP+TN), which is the percentage of borrowers with bad credit (delinquent on loan) mistaken for having good credit; (3) Specificity=TN/(FP+TN), which is the percentage of borrowers with bad credit who are classified as having bad credit; and (4) False Discovery Rate (FDR)=FP/(TP+FP), which is the percentage of borrowers classified as having good credit that do not actually have good credit; and (5) Precision=TP/(TP+FP)=1−FDR, which percentage of borrowers classified as having good credit who actually have good credit.

In some embodiments, the ROC may be plotted by the model generation module 214 with the TPR on the vertical axis, and the FPR on the horizontal axis. Each score (probability cutoff value) of a borrower may generate one point on the ROC curve in which a probability cutoff value is related to the probability of “condition+”, or the probability of a borrower not defaulting on a loan. In such embodiments, the model generation module 214 may construct the ROC curve from approved loans included in the historical borrower data of the alternative loan approval process, such that at each point on the ROC, the model generation module 214 may classify every approved loan in one of four categories: TP, FP, TN, and NP. Further, since K-S=(TPR−FPR)=TPR+specificity−1, the K-S statistic includes the difference between the ordinate and abscissa at each point on the ROC curve. Accordingly, the K-S statistic may provide model coefficients for relationship attributes that are useful for calculating the intermediate borrower score of borrowers.

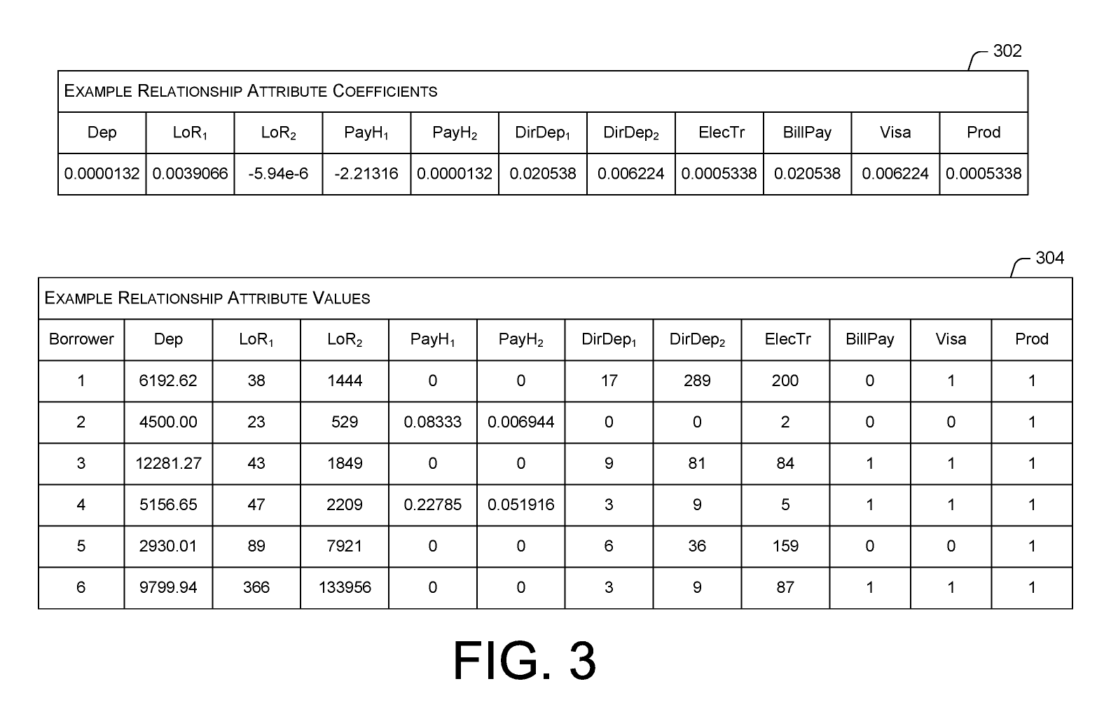

In some embodiments, the model generation module 214 may correct for selection bias in the statistical model 108. Selection bias may be introduced due to incomplete randomness in the sample set of borrowers that contributed historical borrower data for the construction of the statistical model 108. Selection bias in the statistical model 108 may cause marginal probability to over-estimate the likelihood of loan repayment relative to conditional probability. Such an effect may be worse for loan applications of borrowers with a lower repayment likelihood, which means the use of the statistical model 108 may lead to a higher than expected loan default rate. In at least one embodiment, the model generation module 214 may compensate for such selection bias such that a plot of marginality probability along a y-axis and conditional probability along an x-axis for the probability of loan default by the sample set of borrowers line up or approximately line up on a 45-degree straight line. In this way, the resultant model coefficients provided by the statistical model 108 may be compensated for the selection bias. For illustrative purposes, Table 302 of FIG. 3 shows example values of the relationship attribute coefficients that are provided by the statistical model 108.

The input module 214 may receive a loan request of a borrower that is inputted via a user interface. For example, the loan request may be initiated by the borrower 110 via the online portal 118. In turn, the input module 214 may retrieve the relationship attribute values of borrower from the relationship attribute data sources 130. For example, the relationship attributes of the borrower may include an aggregate deposit (Dep) attribute, one or more lengths of relationship (LoR) attribute, one or more payment history (PayH) attribute, a bill pay (BillPay) attribute, an affiliate (Aff) attribute, and/or a banking product (Prod) attribute. For illustrative purposes, Table 304 of FIG. 3 lists hypothetical relationship attributes of a set of borrowers and their corresponding relationship attribute values. As shown, the aggregate deposit (Dep) attribute measures the aggregate deposit balance of a borrower with the lender financial institution during a transaction period. Each length of relationship (LoR) attribute measures an amount of time that the borrower has had an account with the lender financial institution. Each payment history (PayH) attribute quantifies the numbers of late payments to a total number of payments for an account by measuring a percentage of late payments to total payments. An electronic transaction (ElecTr) attribute measures the number of electronic transactions for which the borrower is a primary account holder. The bill pay (BillPay) attribute measures indicates whether the borrower is using a bill pay product of the financial institution. The affiliate (Aff) attribute measures the number of financial products (e.g., credit card, charge card, etc.) from an affiliate financial institution the borrower is using. The banking product (Prod) attribute measures the number of financial institution products for which the borrower is a primary account holder. In some embodiments, the input module 214 may obtain the values of a relationship attribute directly from a relationship attribute data source. In other embodiments, the input module 214 may use a function to derive a relationship attribute value from the data in one or more relationship attribute data sources.

The borrower score module 216 may apply the attribute value coefficients to corresponding relationship attribute values of a borrower, such as the borrower 110, to obtain an intermediate borrower score. In some embodiments, the borrower score module 216 may apply transformation to specific relationship attribute values before applying the relationship attribute coefficients to the relationship attribute values. The transformations that are applied may be specified by a predetermined borrower score formula. The predetermined borrower formula may be commonly applied to a group or borrowers, or tailored for one or more specific borrowers. The transformations may include a natural log transformation, a logarithmic transformation, a square root transformation, a cube root transformation, an exponential transformation, a reciprocal transformation, and/or so forth. For example, the borrower score module 216 may be configured to apply a logarithmic transformation to a LoR attribute value. Thus, a LoR value of 36 months is converted into a transformed LoR value of 1.556302501. In another example, the borrower score module 216 may be configured to apply a natural log transformation to the direct deposit attribute value. Thus, if the number of direct deposit is 50, the natural log transformation of this value is 1.386294361. In another example, the borrower score module 216 may be configured to apply a reciprocal transformation to the affiliate attribute. Thus, if the Aff attribute value is 1, the application of the reciprocal transformation (1/x) to this value of 1 generates a transformed value of 0.25.

In other instances, the value transformation applied by the borrower score module 216 to a particular relationship attribute value may involve comparing the value to a predetermined threshold value. Subsequently, the borrower score module 216 may assign a new value to take place of the particular relationship attribute value when the relationship attribute value is less than, more than, or equal to the predetermined threshold value. For example, a transformation rule for a payment history attribute may state for PayH >5%, true=4, false=2. Thus, a payment history attribute value of “2%” results in a newly assigned transformed payment attribute value of “2”. In another example, a transformation rule for an electronic transaction attribute may state for ElectTr >2, true=1, false=0. Thus, an electric transaction attribute value of “4” results in a newly assigned transformed electronic transaction attribute value of “1”. In an additional example, a transformation rule for an affiliate attribute value may state for Aff <0.6505, true=10, false=0. Thus, an affiliate attribute value of “0.2500” results in a newly assigned affiliate attribute value of “10”.

Following the transformations, the borrower score module 216 may apply the relationship attribute coefficients to the corresponding relationship attribute values to generate a borrower score for a borrower. In various embodiments, the application of the relationship attribute coefficients may involve multiplying or transformed relationship attribute values with their corresponding coefficients. The resultant products of the multiplied pairs are then added or subtracted from each other according to the predetermined borrower score formula to generate the borrower score. In one example implementation, the relationship attribute coefficients and their corresponding relationship attribute values for a borrower may be as follows:

| LoR | PayH | DirDep | ElectTr | Aff | BillPay |
|---|---|---|---|---|---|
| Coefficient | Coefficient | Coefficient | Coefficient | Coefficient | Coefficient |
| 1.34253607 | 0.6392747 | 1.2225378 | 1.33334450 | 0.342607675 | 1.2561607 |
| LoR | PayH | DirDep | ElectTr | Aff | BillPay |
| Value | Value | Value | Value | Value | Value |
| 1.556302501 | 2 | 1.386294361 | 1 | 0 | 0 |

In such an example, the addition and subtraction operations may be configured by a borrower score formula as follows:

(LoR Coefficient×Lor Value)+(PayH Coefficient×PayH Value)+(DirDep Coefficient×DirDep Value)−(ElectTr Coefficient×ElectTr Value)+(Aff Coefficient×Aff value)−(BillPay Coefficient×BillPay Value)

Accordingly, the borrower score of the borrower may be calculated as follows:

(1.34253607×1.556302501)+(0.6392747×2)+(1.2225378×1.386294361)−(1.33334450×1)+(0.342607675×0)+(1.2561607×0)=5.2533445.

Alternatively, for the example shown in FIG. 3, the addition and subtraction operations may be configured by a borrower score formula as follows:

(Dep Coefficient×Dep Value)+(LoR Coefficient₁×Lor Value₁)−(LoR Coefficient₂×Lor Value₂)−(PayH Coefficient₁×PayH Value₁)−(PayH Coefficient₂×PayH Value₂)+(DirDep Coefficient₁×DirDep Value₁)+(DirDep Coefficient₂×DirDep Value₂)+(ElectTr Coefficient×ElectTr Value)+(BillPay Coefficient×BillPay Value)+(Aff Coefficient×Aff value)+(Aff Coefficient×Aff value)+(Prod Coefficient×Prod value)

Accordingly, the borrower score of the first borrower listed in Table 304 may be calculated as follows:

(0.0000132×6129.62)+(0.0039066×38)−(5.95e−06×1444)−(2.21316×0)+(1.965128×0)+(0.020538×17)−(0.0006224×289)+(0.0005338×200)+(0.1727319×0)+(0.0877197×1)+(0.922945×1)=1.507467.

Likewise, applying the borrower formula to all the applicants listed in the Table 304 generates the following borrower scores:

| | Borrower | | | | | |
|---|---|---|---|---|---|---|
| | No. 1 | No. 2 | No. 3 | No. 4 | No. 5 | No. 6 |
| Score | 1.50746708 | 0.89933986 | 1.68175841 | 1.07836477 | 1.44787438 | 2.04798621 |

The delinquency probability module 218 may use the borrower score that is generated by the borrower score module 216 to calculate a probability that the borrower is able to repay a loan without having a predetermined number of days in delinquency, such as 30 or more days. In various embodiments, a Standard Normal Cumulative Distribution Function (CDF) may be applied to the intermediate borrower score to calculate the probability. Since the statistical model is constructed by the model generation module 214 from a standard normal distribution, i.e., mean of zero and standard deviation of one, each borrower score calculated by the borrower score module 216 is a normalized score. Accordingly, the borrower score may be passed directly to the Standard Normal CDF to calculate the probability that the borrower, conditional on observed characteristics, will not enter into 30 or more day delinquency. For example, if the value of the Standard Normal CDF at a linear score of x is denoted as Φ(x), the borrower score module 218 calculates Φ(x) for each borrower.

Evaluating the Standard Normal CDF involves the computation of an integral that has no closed form solution, i.e., the computation of

$${\int }_{- ∞}^{∞} \frac{1}{2 π} * {e}^{\frac{- {x}^{2}}{2} dx} .$$

This means that probabilities are calculated based on numerical approximations. Thus, the borrower score module 216 may use several different options to calculate a probability based on a borrower score. In one example, the borrower score module 216 may use the Excel function NORM.S.DIST(x,TRUE) to calculate the probability. In another example, the borrower score module 216 may use the function pnorm(x, mean=0, sd=1) of the open source statistical computing software environment R to calculate the probability.

Alternatively, the borrower score module 216 may apply a Standard Normal tables or a Taylor series approximation to the borrower score to calculate the probability. Accordingly, with respect to Borrower No. 1 listed in Table 304, the probability may be calculated as Φ(1.507467084)=0.934155. Likewise, the borrower score module 216 may generate the following probabilities for all of the borrowers listed in Table 304:

| | Borrower | | | | | |
|---|---|---|---|---|---|---|
| | No. 1 | No. 2 | No. 3 | No. 4 | No. 5 | No. 6 |
| Score | 1.50746708 | 0.89933986 | 1.68175841 | 1.07836477 | 1.44787438 | 2.04798621 |
| Probability (Φ) | 0.934155 | 0.815764 | 0.953692 | 0.859564 | 0.926174 | 0.979719 |

The borrower score is compared by the loan approval module 220 to a predetermined cutoff threshold. If the borrower score is greater than the predetermined cutoff threshold, the loan request for the borrower is approved. However, if the borrower score is below the predetermined cutoff threshold, the loan request is declined. Analytical scoring involves picking a best first guess of the predetermined cutoff score by maximizing the K-S statistic, as calculated for each point on the ROC curve. The ROC curve, in turn, measures the difference between the “True Positive Rate” (TPR) and the “False Positive Rate” (FPR), K-S=(TPR-FPR). TPR is the percent of good credit scored as good credit and FPR is the percent of bad credit mistaken for good credit. The calculation of K-S requires knowledge of the loans not approved that will not enter the predetermined (e.g., 30 or more days) of delinquency. In various embodiments, the predetermined cutoff threshold may be established at 0.90. Accordingly, with respect to the example illustrated in Table 304, Borrowers Nos. 2 and 4 failed to qualify for loans, while the remaining borrowers are deemed by the loan approval module 220 as being approved for loans. Subsequently, the loan approval module 220 may send the loan decision an online portal (e.g., the online portal 118) for presentation to a borrower (e.g., the borrower 110).

The loan amount module 222 may use an aggregated monthly deposit amount of a borrower at the financial institution to determine the loan amount awarded to the borrower for each approved interest-based loan request. In some embodiments, the loan amount module 222 may use a predetermined percentage of the aggregated monthly deposit amount to determine the awarded loan amount. For example, the predetermined percentage of the aggregated monthly deposit amount may be established at 40%, 50%, or some other percentage. In some instances, deposit account exclusions may be subtracted from this aggregated monthly deposit amount for the purpose of determining the percentage. In other embodiments, the loan amount module 222 may use the predetermined percentage of the aggregated monthly deposit amount (with or without the exclusions) as a base loan amount for a loan, and add an additional loan amount based on a tiered-value scale. The tiered-value scale may provide additional loan amounts based on one or more of a particular relationship attribute value of the borrower, a credit score of the borrower, another third-party score for the borrower. For example, the credit score may be a FICO score as provided by the Fair Issac Corp., a VantageScore as provided by VantageScore Solutions, LLC, a CE score as provided by CE Analytics, etc. Thus, in instances in which a loan is approved, the loan approval module 220 may further send the approved loan amount for presentation to the borrower, such as the borrower 110. For example, the approved loan amount may be sent to the online portal 118 for presentation to the borrower 110.

The user interface module 224 may enable an administrator to interact with the statistical loan engine 102 via data input devices and data output devices. The data input devices may include, but are not limited to, combinations of one or more of keypads, keyboards, mouse devices, touch screens that accept gestures, microphones, voice or speech recognition devices, and any other suitable devices or other electronic/software selection methods. The data output devices may include visual displays, speakers, virtual reality (VR) gear, haptic feedback devices, and/or so forth. In some embodiments, the administrator may use the user interface module 224 to cause the loan approval module 220 to set or adjust cutoff thresholds for loan approvals. The administrator may monitor portfolio metrics, such as charge offs, to achieve a desired balance between portfolio risk and return. Raising the cutoff threshold leads to lower loan defaults but also lower loan volume. Lowering the cutoff will have the opposite effect, meaning that the loan default rate is expected to rise but loan volume is expected to increase. Accordingly, the administrator may initially choose a cutoff threshold that maximizes the K-S statistic, and then modify the cutoff threshold based on the actual portfolio metrics. In other embodiments, the administrator may use the user interface module 224 to configure a borrower score formula for use by the borrower score module 216 with respect to one or more borrowers.

The data store 226 may store data that are used or generated by the statistical loan engine 102. The data store 226 may include one or more databases, such as relational databases, object databases, object-relational databases, and/or key-value databases. In at least some embodiments, the data store 226 may store historical loan approval data 226 associated with an alternative model, calculated relationship attribute coefficient values 228, relationship attribute values 230, borrower scores 232, a score cutoff threshold 234, loan decisions 236 for individual borrowers, and/or other data.

### Example Processes

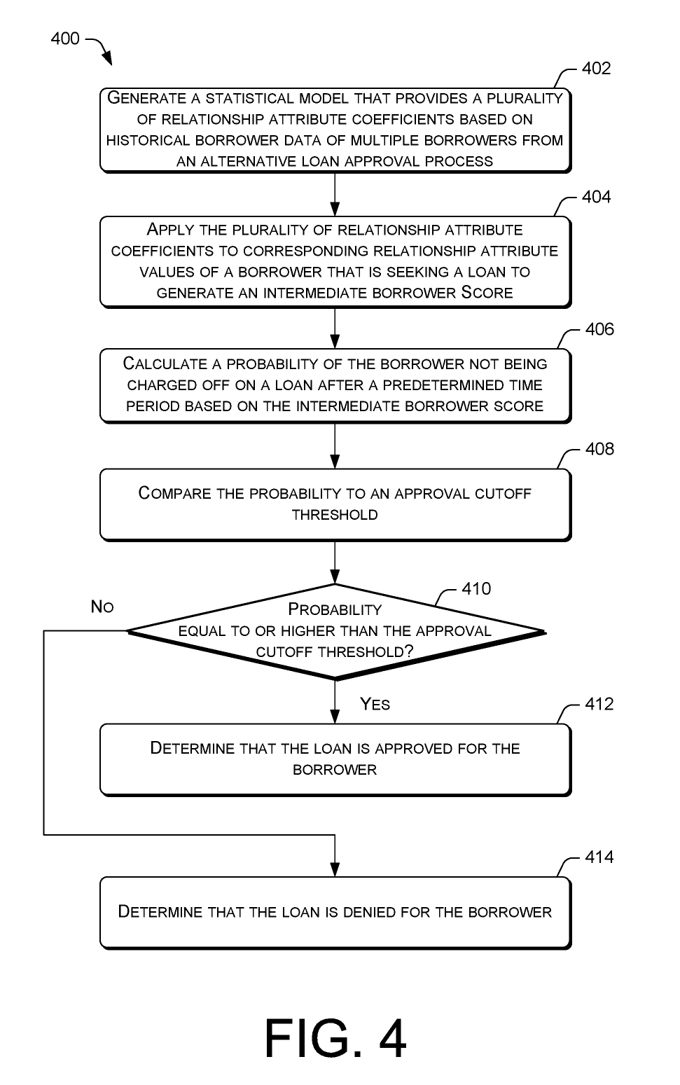

FIGS. 4-6 present illustrative processes 400-600 for performing statistical analysis on the relationship attributes of a borrower to make a loan decision. Each of the processes 400-600 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-600 are described with reference to the environment 100 of FIG. 1.

FIG. 4 is a flow diagram of an example process 400 for using a statistical model to perform statistical analysis on the relationship attributes of a borrower to make a loan decision. At block 402, the statistical loan engine 102 may generate a statistical model that provides a plurality of relationship attribute coefficients based on data from an alternative loan approval process. In various embodiments, the statistical model is specified and estimated based on historical borrower data of multiple borrowers from the alternative loan approval process using a selection equation and a probit equation. For example, the alternative approval process may use a heuristic model that generates a loan qualifier score using multiple relationship attributes.

At block 404, the statistical loan engine 102 may apply the plurality of borrower coefficients to corresponding relationship attribute values of a borrower that is seeking a loan to generate an intermediate score. The statistical loan engine 102 may obtain relationship attribute values of borrowers from the relationship attribute data sources 130. For example, the relationship attributes of a borrower may include an aggregate deposit (Dep) attribute, one or more lengths of relationship (LoR) attribute, one or more payment history (PayH) attribute, a bill pay (BillPay) attribute, an affiliate (Aff) attribute, and/or a banking product (Prod) attribute.

At block 406, the statistical loan engine 102 may calculate a probability of the borrower not being charged off on a loan following a predetermined time period based on the intermediate borrower score. In various embodiments, the statistical loan engine 102 may apply a distribution function, such as a Standard Normal Cumulative Distribution Function (CDF), to the intermediate borrower score to calculate the probability.

At block 408, the statistical loan engine 102 may compare the probability to an approval cutoff threshold to determine whether the borrower is approved for lending. At decision block 410, if the statistical loan engine 102 determines that the probability is equal to or higher than the approval cutoff threshold (“yes” at decision block 410), the process 400 may proceed to block 412. At block 412, the statistical loan engine 102 may determine that the loan is approved for the borrower. However, if the statistical loan engine 102 determines that the probability is lower than the approval cutoff threshold (“no” at decision block 410), the process 400 may proceed to block 414. At block 414, the statistical loan engine 102 may determine that the loan is denied for the borrower.

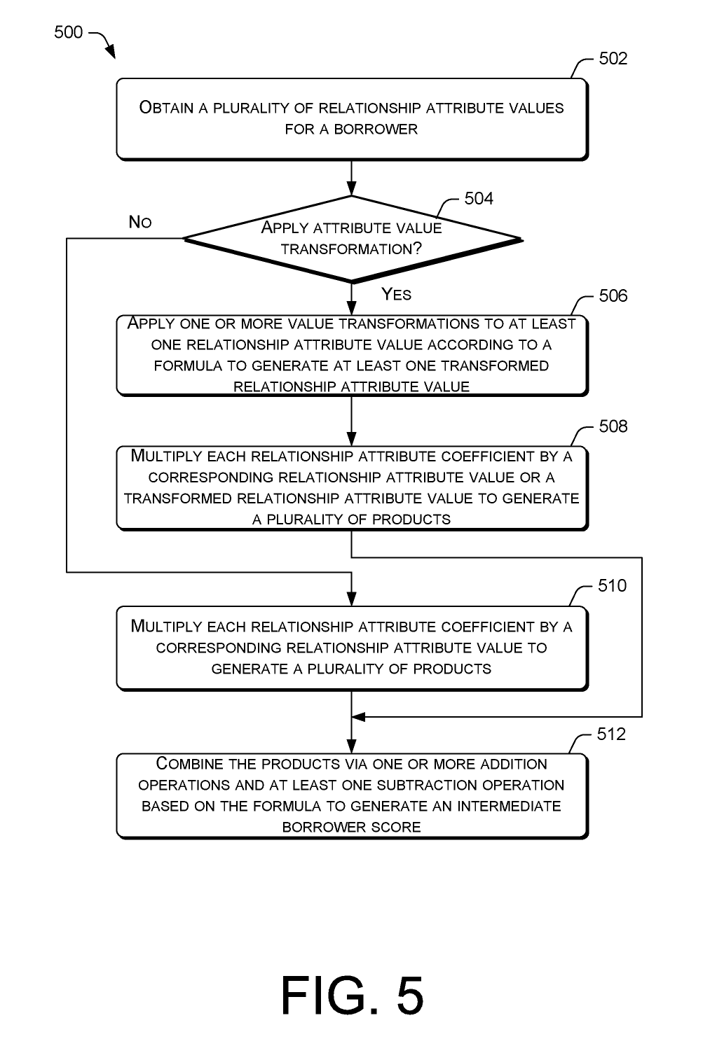

FIG. 5 is a flow diagram of an example process 500 for applying relationship attribute coefficients to corresponding relationship attribute values to generate an intermediate borrower score. The process 500 further describes block 404 of the process 400. At block 502, the statistical loan engine 102 may obtain a plurality of relationship attribute values for a borrower. In various embodiments, the statistical loan engine 102 may obtain relationship attribute values of borrowers from the relationship attribute data sources 130.

At decision block 504, the statistical loan engine 102 may determine whether attribute value transformation is to be applied to one or more attribute values. In various embodiments, the statistical loan engine 102 may make such a determination based on predetermined borrower score formula for the borrower. Thus, if the statistical loan engine 102 determines that attribution value transformation is to be applied (“yes” at decision block 504), the process 500 may proceed to block 506. At block 506, the statistical loan engine 102 may apply one or more value transformations to at least one relationship attribute value according to the borrower score formula. In some instances, the transformations may include a natural log transformation, a logarithmic transformation, a square root transformation, a cube root transformation, an exponential transformation, a reciprocal transformation, and/or so forth. In other instances, the value transformation may involve comparing a relationship attribute value to a predetermined threshold value, and assigning a new value to take place of the particular relationship attribute value when the relationship attribute value is less than, more than, or equal to the predetermined threshold value.

At block 508, the statistical loan engine 102 may multiply each relationship attribute coefficient by a corresponding relationship attribute value or a transformed relationship attribute value to generate a plurality of products. However, returning to decision block 504, if the statistical loan engine 102 determines that no attribution value transformation is to be applied (“no” at decision block 504), the process 500 may proceed to block 510.

At block 510, the statistical loan engine 102 may multiply each relationship attribute coefficient by a corresponding relationship attribute value to generate a plurality of products. At block 512, the statistical loan engine 102 may combine the products via one or more addition operations and at least one subtraction operation based on the predetermined borrower score formula to generate an intermediate borrower score.

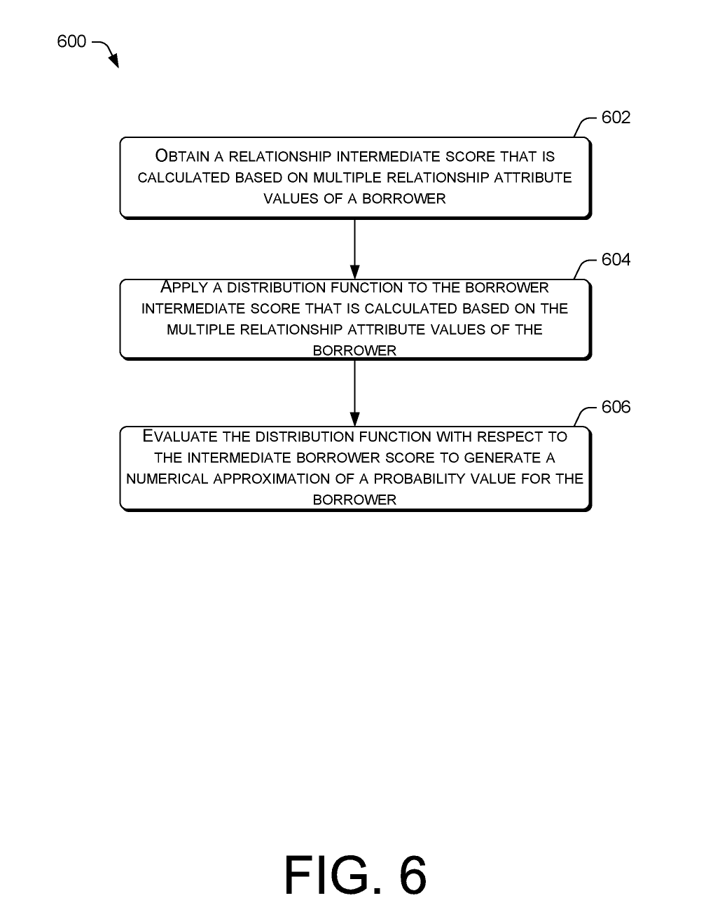

FIG. 6 is a flow diagram of an example process 600 for using a distribution function to calculate a probability value that determines whether a borrower is qualified for a loan. The process 600 further describes block 406 of the process 400. At block 602, the statistical loan engine 102 may obtain a borrower intermediate score that is calculated based on multiple relationship attribute values of a borrower. At block 604, the statistical loan engine 102 may apply a distribution function to the borrower intermediate score that is calculated based on the multiple relationship attribute values of the borrower. In various embodiments, the distribution function may be the Standard Normal Cumulative Distribution Function (CDF).

At block 606, the statistical loan engine 102 may evaluate the distribution function with respect to the intermediate borrower score to generate a numerical approximation of a probability value for the borrower. In one instance, the statistical loan engine 102 may use the Excel function NORM.S.DIST(x,TRUE) to calculate the probability. In another instance, the statistical loan engine 102 may use the function pnorm(x, mean=0, sd=1) of the open source statistical computing software environment R to calculate the probability. Alternatively, the borrower score module 216 may apply Standard Normal tables or a Taylor series approximation to the borrower score to calculate the probability value. The probability value represents the probability of the borrower not being charged off on the loan after a predetermined time period (e.g., 30 days or more).

The statistical model enables a lender financial institution to leverage multiple relationship attributes of a borrower, in view of repayment histories of borrowers with similar attributes, to predict whether the borrower is capable of timely paying back a short-term loan. The statistical model may provide more accurate predictions of loan default probability than traditional techniques that rely solely on a borrower's credit score or a heuristic credit assessment of the borrower. Accordingly, such predictions may reduce incidents of loan defaults, reduce loan decision time, and provide near real-time loan approval or denial decisions to borrowers. Thus, the statistical model makes it practical for financial institutions to receive online requests for short-term loans from their existing customers via the Internet, automatically process the short-term loan requests without human intervention, and render loan decisions in near real-time for providing loans to their existing customers.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system, comprising:
one or more processors; and
memory having instructions stored therein, the instructions, when executed by the one or more processors, cause the one or more processors to perform acts comprising:
generating a statistical model that provides a plurality of relationship attribute coefficients based on historical borrower data of multiple borrowers from an alternative loan approval process;
applying the plurality of relationship attribute coefficients to corresponding relationship attribute values of a borrower that is seeking a loan from a financial institution to generate an intermediate borrower score for the borrower;
calculating a probability of the borrower not being charged off on a loan after a predetermine time period based on the intermediate borrower score;
determining that the loan is approved for the borrower in response to the probability being equal to or higher than an approval cutoff threshold; and
determining that the loan is denied for the borrower in response to the probability being less than the approval cutoff threshold.

2. The system of claim 1, wherein the generating the statistical model includes specifying and estimating the statistical model based on the historical borrower data using a selection equation that relates relationship attributes of the multiple borrowers to whether the multiple borrowers are delinquent on loans, and using a probit equation that quantifies corresponding relationship attributes belonging to each borrower of the multiple borrowers as being related to a classification of being delinquent on a corresponding loan or a classification of not delinquent on the corresponding loan.

3. The system of claim 2, wherein generating the statistical model further includes determining a Receiver Operating Characteristic (ROC) curve and values of associated Kolmogorov-Smirnov (K-S) statistic along the ROC curve based on the statistical model and a validation sub-sample of the historical borrower data to provide the relationship attribute coefficients.

4. The system of claim 1, wherein the historical borrower data includes relationship attributes of the multiple borrowers, the relationship attributes of a borrower of the multiple borrowers includes one or more of a length of relationship of the borrower with the financial institution, a payment history that includes a number of times the borrower paid open and closed loan payments on time, a direct deposit history that includes a number of direct deposits for which the borrower is a primary account holder, electronic transaction history that includes a number of electronic transactions for which the borrower is a primary account holder, an aggregated deposit balance during a transactional period, whether a loan qualifier score resulted in the borrower being approved for a corresponding loan, or whether the borrower is delinquent in paying back the corresponding loan.

5. The system of claim 4, wherein the alternative loan approval process uses a heuristic model to determine whether to approval or deny loans to the multiple borrowers based on the relationship attributes of the multiple borrowers.

6. The system of claim 1, wherein the multiple borrowers are a sample set of borrowers selected from the multiple borrowers, and wherein the relationship attribute coefficients generated from the statistical model are adjusted to correct for a selection bias in the sample set of borrowers.

7. The system of claim 1, wherein the applying the plurality of relationship attribute coefficients comprise:
applying one or more value transformations to at least one relationship attribute value of the borrower according to a borrower score formula to generate at least one transformed relationship attribute value;
multiplying each relationship attribute coefficient of the relationship attribute coefficients by a corresponding relationship attribute value or a corresponding transformed relationship attribute value of the borrower to generate a plurality of products; and
combining the products via one or more addition operations and at least one subtraction operation based on the borrower score formula to generate the intermediate borrower score.

8. The system of claim 7, wherein applying a value transformation to a relationship attribute value includes applying a natural log transformation, a logarithmic transformation, a square root transformation, a cube root transformation, an exponential transformation, or a reciprocal transformation to the relationship attribute value.

9. The system of claim 7, wherein applying a value transformation to a relationship attribute value includes comparing the relationship attribute value to a predetermined threshold value, and assigning a new value to take place of the relationship attribute value when the relationship attribute value is less than, more than, or equal to the predetermined threshold value.

10. The system of claim 1, wherein the calculating the probability includes applying a distribution function to the borrower intermediate score that is calculated based on the corresponding relationship attribute values of the borrower, and evaluating the distribution function to generate a numerical approximation of a probability value that indicates the probability of the borrower not being charged off on a loan after a predetermine time period.

11. The system of claim 1, wherein the corresponding relationship attribute values includes one or more of an aggregate deposit attribute value that measures an aggregate deposit balance of a borrower with the financial institution during a transaction period, a length of relationship attribute value that measures an amount of time that the borrower has had an account with the financial institution, a payment history attribute value that quantifies a percentage of late payments to total payments of the borrower, an electronic transaction attribute value that measures a number of electronic transactions for which the borrower is a primary account holder, a bill pay attribute value that indicates whether the borrower is using a bill pay product of the financial institution the borrower, an affiliate attribute value that measures a number of financial products from an affiliate financial institution of the financial institution the borrower is using, or a banking product attribute value that measures a number of products of the financial institution for which the borrower is a primary account holder.

12. The system of claim 1, wherein the acts further comprise, in response to a determination that the loan is approved, determining an awarded loan amount based at least on an aggregated monthly deposit amount of the borrower at the financial institution.

13. The system of claim 12, wherein the awarded loan amount includes a percentage of the aggregated monthly deposit amount of the borrower and an additional loan amount that is awarded based on one or more of a particular relationship attribute value of the borrower or a credit score of the borrower.

14. One or more computer-readable media storing computer-executable instructions that upon execution cause one or more processors to perform acts comprising:
generating a statistical model that provides a plurality of relationship attribute coefficients based on historical borrower data of a multiple borrowers from an alternative loan approval process;
applying the plurality of relationship attribute coefficients to corresponding relationship attribute values of a borrower that is seeking a loan from a financial institution to generate an intermediate borrower score for the borrower;
calculating a probability of the borrower not being charged off on a loan after a predetermine time period based on the intermediate borrower score;
determining that the loan is approved for the borrower in response to the probability being equal to or higher than an approval cutoff threshold; and
determining an awarded loan amount based at least on an aggregated monthly deposit amount of the borrower at the financial institution following a determination that the loan is approved.

15. The one or more computer-readable media of claim 14, wherein the awarded loan amount includes a percentage of the aggregated monthly deposit amount of the borrower and an additional loan amount that is awarded based on one or more of a particular relationship attribute value of the borrower or a credit score of the borrower.

16. The one or more computer-readable media of claim 14, wherein the generating the statistical model includes specifying and estimating the statistical model based on the historical borrower data using a selection equation that relates relationship attributes of the multiple borrowers to whether the multiple borrowers are delinquent on loans, and using a probit equation that quantifies corresponding relationship attributes belonging to each borrower of the multiple borrowers as being related to a classification of being delinquent on a corresponding loan or a classification of not delinquent on the corresponding loan.

17. The one or more computer-readable media of claim 16, where in the generating the statistical model further includes determining a Receiver Operating Characteristic (ROC) curve and values of associated Kolmogorov-Smirnov (K-S) statistic along the ROC curve based on the statistical model and a validation sub-sample of the historical borrower data to provide the relationship attribute coefficients.

18. The one or more computer-readable media of claim 14, wherein the applying the plurality of relationship attribute coefficients comprise:
applying one or more value transformations to at least one relationship attribute value of the borrower according to a borrower score formula to generate at least one transformed relationship attribute value;
multiplying each relationship attribute coefficient of the relationship attribute coefficients by a corresponding relationship attribute value or a corresponding transformed relationship attribute value of the borrower to generate a plurality of products; and
combining the products via one or more addition operations and at least one subtraction operation based on the borrower score formula to generate the intermediate borrower score.

19. The one or more computer-readable media of claim 14, the calculating the probability includes applying a distribution function to the borrower intermediate score that is calculated based on the corresponding relationship attribute values of the borrower, and evaluating the distribution function to generate a numerical approximation of a probability value that indicates the probability of the borrower not being charged off on a loan after a predetermine time period.

20. A computer-implemented method, comprising:
generating, at one or more computing devices, a statistical model that provides a plurality of relationship attribute coefficients based on historical borrower data of a multiple borrowers from an alternative loan approval process, the alternative loan approval process uses a heuristic model to determine whether to approval or deny loans to the multiple borrowers based on the relationship attributes of the multiple borrowers, in which the relationship attributes of each borrower of the multiple borrowers quantifies a relationship history of each borrower with a financial institution;
applying, at the one or more computing devices, the plurality of relationship attribute coefficients to corresponding relationship attribute values of a borrower that is seeking a loan from the financial institution to generate an intermediate borrower score for the borrower;
calculating, at the one or more computing devices, a probability of the borrower not being charged off on a loan after a predetermine time period based on the intermediate borrower score;
determining, at the one or more computing devices, that the loan is approved for the borrower in response to the probability being equal to or higher than an approval cutoff threshold or that the loan is denied for the borrower in response to the probability being less than the approval cutoff threshold; and
adjusting, at the one or more computing devices, the approval cutoff threshold in response to a user input.
